(19) United States
(12) Patent Application Publication
(10) Pub. No.: US 2024/0305648 A1
(43) Pub. Date: Sep. 12, 2024

(54) DETERMINING ATTRIBUTION FOR CYBER INTRUSIONS

(71) Applicant: INTERNATIONAL BUSINESS MACHINES CORPORATION, ARMONK, NY (US)

(72) Inventors: Ramon Lloyd Garo, Miami, FL (US); Faith Opiyo, Nieuw Vennep (NL)

(21) Appl. No.: 18/181,354

(22) Filed: Mar. 9, 2023

(51) Int. Cl. H04L 9/40

(52) U.S. Cl. CPC H04L 63/1416; H04L 63/1425; H04L 63/1441

(57) ABSTRACT

A method, computer system, and a computer program product for cyber intrusion attribution is provided. The present invention may include initiating incident data tracking and actor intelligence data tracking in response to an intrusion. The present invention may include generating an intrusion comparison data set for each of the plurality of categories for both the incident data and the actor intelligence data. The present invention may include comparing each intrusion comparison data set for the incident data with a corresponding intrusion comparison data set for the actor intelligence data. The present invention may include identifying a potential actor attribution based on comparing each of the intrusion comparison data sets for the incident data with the corresponding intrusion comparison data set for the actor intelligence data.

### BACKGROUND

The present invention relates generally to the field of computing, and more particularly to cybersecurity.

In the field of cybersecurity, attribution may be identifying an entity which may be responsible for carrying out a cybersecurity incident. The leaders of cybersecurity strategy at larger organizations, especially those in frequently affected industry sectors such as technology or financial services, may also place great importance on attribution for incidents which may affect their organization. Accordingly, a system for determining attribution for cyber intrusions using the similarities between data gathered for a particular incident and data gathered for previous incidents across a plurality of categories may help users and/or organizations in identifying actors, campaigns, attributes across different categories, and/or granular information on the cyber intrusion.

For incident responders, attribution may be challenging if incidents do not reuse known indicators of compromise that may be published in cyber actor intelligence.

### SUMMARY

Embodiments of the present invention disclose a method, computer system, and a computer program product for cyber intrusion attribution. The present invention may include initiating incident data tracking and actor intelligence data tracking in response to an intrusion. The present invention may include generating an intrusion comparison data set for each of the plurality of categories for both the incident data and the actor intelligence data. The present invention may include comparing each intrusion comparison data set for the incident data with a corresponding intrusion comparison data set for the actor intelligence data. The present invention may include identifying a potential actor attribution based on comparing each of the intrusion comparison data sets for the incident data with the corresponding intrusion comparison data set for the actor intelligence data.

In another embodiment, the method may include processing the incident data and the actor intelligence data and augmenting the incident data and the actor intelligence data with extended indicators of compromise.

In a further embodiment, the method may include generating a fuzzy hash for each of the intrusion comparison data sets by applying one or more similarity algorithms in matching the corresponding intrusion comparison data set based on the fuzzy hashes.

In yet another embodiment, the method may include creating an incident aggregate category intrusion comparison data set across the plurality of categories; and creating an actor intelligence aggregate category intrusion comparison data set across the plurality of categories.

In addition to a method, additional embodiments are directed to a computer system and a computer program product for cyber intrusion attribution.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment;

FIG. 2 is an operational flowchart illustrating a process for cyber intrusion attribution according to at least one embodiment; and

FIG. 3 depicts a block diagram illustrating the flow of incident data and actor intelligence data tracking according to at least one embodiment.

### DETAILED DESCRIPTION

The following described exemplary embodiments provide a system, method and program product for cyber intrusion attribution. As such, the present embodiment has the capacity to improve the technical field of cybersecurity by comprehensively comparing multiple categories of incident data against actor intel data using an algorithm that produces similarity ratings between incidents, specific intrusion campaigns, and/or cyber intrusion actors. More specifically, the present invention may include initiating incident data tracking and actor intelligence data tracking in response to an intrusion. The present invention may include generating an intrusion comparison data set for each of the plurality of categories for both the incident data and the actor intelligence data. The present invention may include comparing each intrusion comparison data set for the incident data with a corresponding intrusion comparison data set for the actor intelligence data. The present invention may include identifying a potential actor attribution based on comparing each of the intrusion comparison data sets for the incident data with the corresponding intrusion comparison data set for the actor intelligence data.

As described previously, in the field of cybersecurity, attribution may be identifying an entity which may be responsible for carrying out a cybersecurity incident. The leaders of cybersecurity strategy at larger organizations, especially those in frequently affected industry sectors such as technology or financial services, may also place great importance on attribution for incidents which may affect their organization.

For incident responders, attribution may be challenging if incidents do not reuse known indicators of compromise that may be published in cyber actor intelligence.

Therefore, it may be advantageous to, among other things, initiate incident data tracking and actor intelligence data tracking in response to an intrusion, generate an intrusion comparison data set for each of the plurality of categories for both the incident data and the actor intelligence data, compare each intrusion comparison data set for the incident data with a corresponding intrusion comparison data set for the actor intelligence data, and identify potential actor attribution based on comparing each of the intrusion comparison data sets for the incident data with the corresponding intrusion comparison data set for the actor intelligence data.

According to at least one embodiment, the present invention may improve cyber intrusion attribution by comprehensively comparing multiple categories of incident data against actor intelligence data using an algorithm that produces similarity ratings between incidents and specific intrusion campaigns and/or cyber intrusion actors.

According to at least one embodiment, the present invention may improve cyber intrusion attribution by using incident data and actor intelligence data from a plurality of categories, the plurality of categories may include, but are not limited to including, Indicators of Compromise (IoCs) (e.g., Category 1 data), Tactics and Techniques (TTs) (e.g., Category 2 data), Extended IoC Characteristics (EIoCCs) (e.g., Category 3 data), and/or Miscellaneous Actor details (e.g., Category 4 data).

According to at least one embodiment, the present invention may improve cyber intrusion attribution by using one or more similarity algorithms for comparing incident data with actor intelligence data across a plurality of data categories in matching corresponding intrusion comparison data sets based on fuzzy hashes.

According to at least one embodiment, the present invention may improve cyber intrusion attribution by utilizing data which is more difficult for actors to change, such as, but not limited to, Tactics and Techniques (TTs) (e.g., Category 2 data), Extended IoC Characteristics (EIoCCs) (e.g., Category 3 data), and/or Miscellaneous Actor details (e.g., Category 4 data).

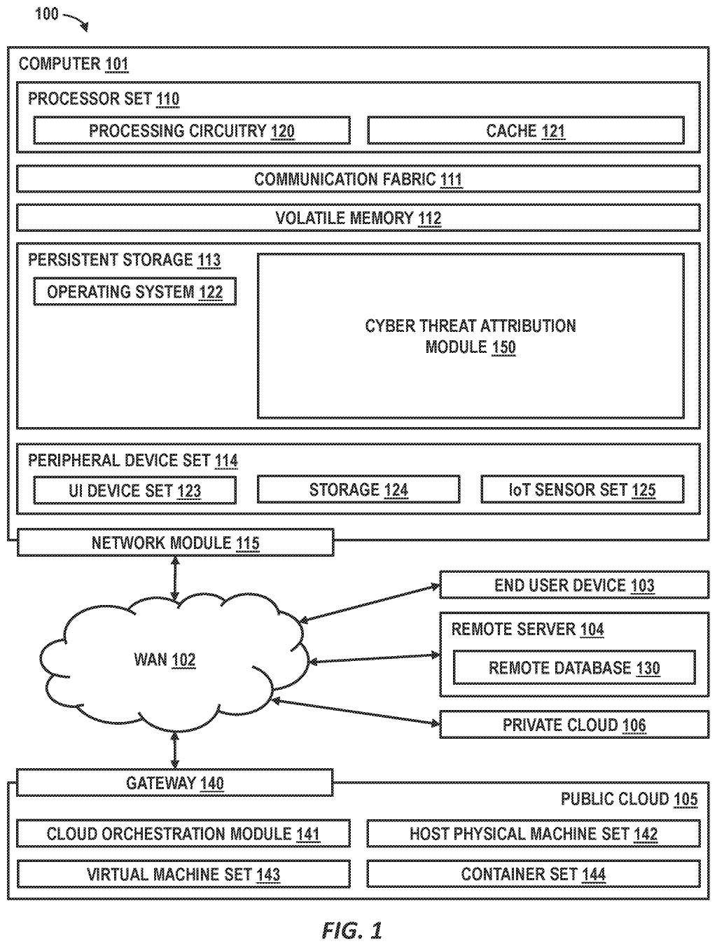

Referring to FIG. 1, Computing environment 100 contains an example of an environment for the execution of at least some of the computer code involved in performing the inventive methods, such as comprehensively comparing multiple categories of incident data against actor intel data using an algorithm that produces similarity ratings between incidents, specific actor campaigns, and/or cyber intrusion actors using the cyber intrusion attribution module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

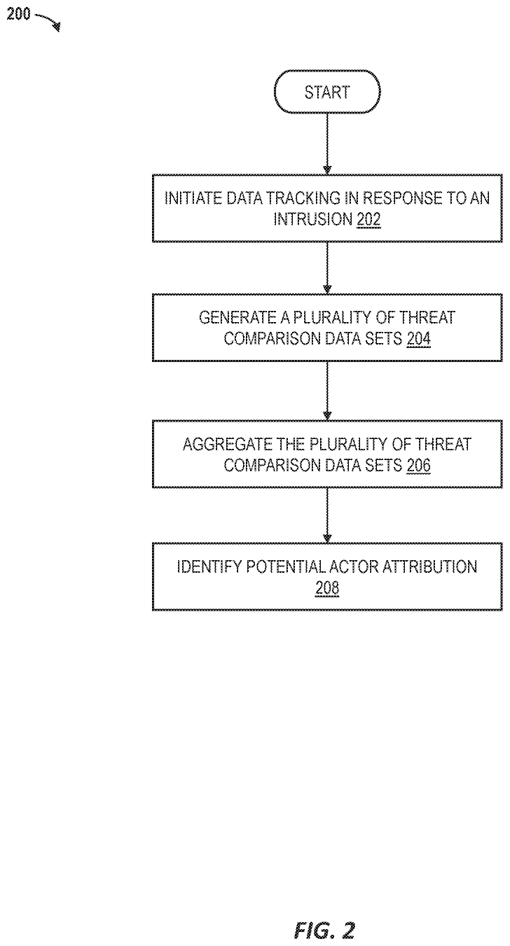

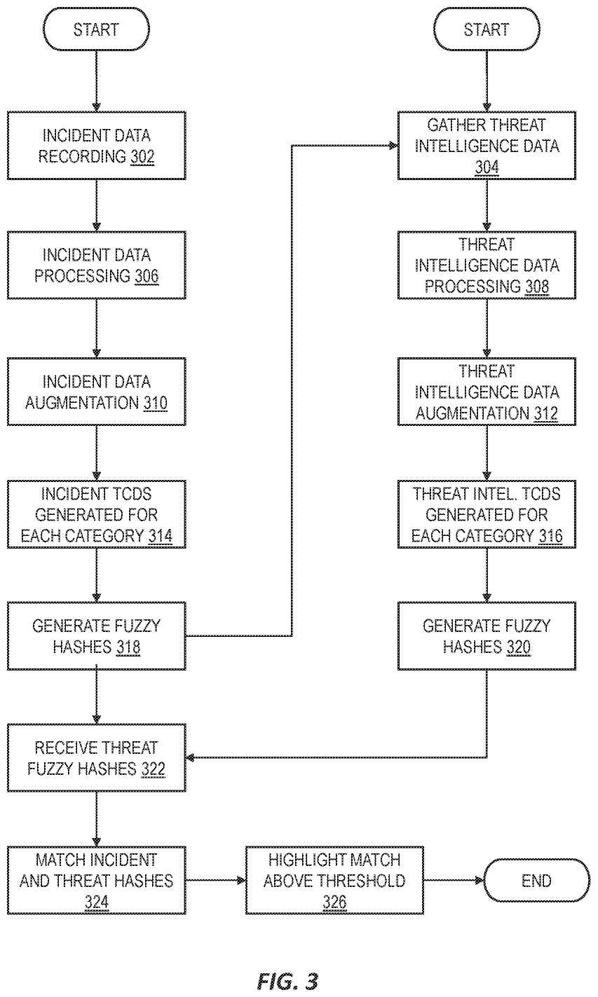

According to the present embodiment, the computer environment 100 may use the cyber intrusion attribution module 150 to comprehensively compare multiple categories of incident data against actor intel data using an algorithm that produces similarity ratings between incidents, specific actor campaigns, and/or cyber intrusion actors. The cyber intrusion attribution method is explained in more detail below with respect to FIGS. 2 and 3.

Referring now to FIG. 2, an operational flowchart illustrating the exemplary cyber intrusion attribution process 200 used by the intrusion analysis module 150 according to at least one embodiment is depicted.

At 202, the cyber intrusion attribution module 150 initiates data tracking in response to a cyber intrusion. The cyber intrusion attribution module 150 may initiate incident data tracking in response to the cyber intrusion by at least, receiving, gathering, and/or recording incident data for each of a plurality of categories.

As will be described in more detail with respect to steps 204-208 and FIG. 3, in a parallel cycle, actor intelligence data may be ingested from external and/or internal intelligence feeds and/or manually entered by one or more cyber intrusion intelligence analysts. The actor intelligence data may have been captured prior to the incident and/or as the incident is ongoing and may mark the beginning of an intelligence cycle. The two independent cycles may be performed in parallel to one another, the incident tracking may be completed in the Incident Tracking Platform and the intel tracking may be completed in an Actor Intelligence Tracking Platform. The actor intelligence data may be primarily collected from external sources, among other sources, based on other incidents which may have been detected by an organization. The Actor Intelligence Tracking Platform may be utilized by the cyber intrusion attribution module 150 in receiving, gathering, and/or recording the actor intelligence data for each of the plurality of categories from the one or more external and/or internal sources. As will be explained in more detail below with respect to at least FIG. 3, while the two independent cycles may be performed in parallel to one another, they may share the information they collect (e.g., the incident data tracking may be utilized to inform the actor intelligence data tracking and vice versa). Communications between the Incident Tracking Platform and the Actor Intelligence Tracking Platform may be facilitated by the cyber intrusion attribution module 150 using integration software, application programming interface (API) calls, and/or manual ingestion, amongst other methods.

The cyber intrusion attribution module 150 may receive and/or track the system incident data for the plurality of categories in an Incident Tracking Platform which may be displayed by the cyber intrusion attribution module 150 in at least an internet browser, dedicated software application, and/or as an integration with a third party software application, such as, but not limited to, IBM Security QRadar® SOAR (IBM Security QRadar® SOAR, and all QRadar-based trademarks are trademarks or registered trademarks of International Business Machines Corporation in the United States, and/or other countries), amongst other IBM Security® platforms. For example, the cyber intrusion attribution module 150 may utilize IBM Security QRadar® SOAR functions such as, incident tracking, incident annotation, playbook automation, amongst other functions, as well as, existing Cybersecurity Incident Response Teams (CSIRT), in gathering system incident data for the plurality of categories.

The cyber intrusion attribution module 150 may track and/or gather actor intelligence data in an Actor Intelligence Tracking Platform which may be displayed by the cyber intrusion attribution module 150 in at least an internet browser, dedicated software application, and/or as an integration with a third party software application, such as, but not limited to, IBM X-Force® Exchange (IBM X-Force® Exchange, and all X-Force-based trademarks are trademarks or registered trademarks of International Business Machines Corporation in the United States, and/or other countries), amongst other IBM Security® platforms. For example, the cyber intrusion attribution module 150 may utilize IBM X-Force® Exchange in tracking and/or gathering actor intelligence data and generating the Intrusion Comparison Data Sets (ICDS) and the corresponding hashes.

The plurality of categories for which the cyber intrusion attribution module 150 may receive incident data may include, but are not limited to including. Indicators of Compromise (IoCs) (e.g., Category 1 data), Tactics and Techniques (TTs) (e.g., Category 2 data), Extended IoC Characteristics (EIoCCs) (e.g., Category 3 data), and/or Miscellaneous Actor details (e.g., Category 4 data). As will be explained in more detail below, EIoCCs (e.g., Category 3 data) may be additional metadata which may be used to enrich the incident data and/or actor intelligence data post processing.

Indicators of Compromise (IoCs) (e.g., Category 1 data), may serve as forensic evidence of potential intrusions on a host system and/or network. IoCs (e.g., Category 1 data) may enable cybersecurity professionals and/or system administrators to detect intrusion attempts and/or other malicious activities. IoCs (e.g., Category 1 data) may be utilized in analyzing a particular actor's techniques and/or behaviors and may provide actionable intelligence. IoCs (e.g., Category 1 data) may be specific to individual cyber intrusion campaigns because cyber intrusion actors may often change the values of the IoCs (e.g., Category 1 data) to increase the difficulty of detection and cyber intrusion attribution. Examples of IoCs (e.g., Category 1 data) may include, but are not limited to including, Internet Protocol (IP) addresses, domains, Uniform Resource Locators (URLs), email addresses, file hashes, specific command line interface commands, amongst other data.

Tactics and Techniques (TTs) (e.g., Category 2 data) may include data describing the behavior of a cyber intrusion actor. Tactics may refer to high level descriptions of goals that cyber intrusion actors may be trying to accomplish. On the other hand, techniques may refer to the methods utilized by the cyber intrusion actors to accomplish the tactic. For example, for the exfiltration tactic, a technique that may be utilized by a cyber intrusion actor is to transfer data to a cloud account to avoid typical file transfers/downloads and/or network-based exfiltration detection.

Extended IoC Characteristics (EIoCCs) (e.g., Category 3 data) may include details and/or metadata which may indicate a possible relationship between incident IoCs and actor intelligence IoCs which may be identified by analyzing IoCs (e.g., Category 1 data). As with tactics and techniques, EIoCCs (e.g., Category 3 data) may be utilized in identifying potential relationships between an incident and actor intelligence without having an exact IoC match. EIoCCs (e.g., Category 3 data) may be collected automatically through the Incident Tracking Platform, the Actor Intelligence Tracking Platform, and/or by analysts. Examples of EIoCCs (e.g., Category 3 data) may include, but are not limited to including, registered ranges to which IP's belong, similarity of domain spelling, similarity of a partial domain, matching and/or similar geolocation information, matching and/or similar domain registration times, file fuzzy hashes, certificates used to sign websites or files, matching and/or similar domain registration details, matching and/or similar Domain Name System (DNS) registration details, matching and/or similar hosting details, matching and/or similar vulnerability details on targeted systems, timeframes of DNS/Domain registration, amongst other details and/or metadata.

Miscellaneous Actor details (e.g., Category 4 data) may include data which encompasses all other notable cyber intrusion actor footprints which may be utilized to further profile an actor not included in Category 1, Category 2, or Category 3. Examples of Miscellaneous Actor details (e.g., Category 4 data) may include, but are not limited to including, cyber intrusion actor operational timeframes, language(s) used by the cyber intrusion actors, cyber intrusion actor type (i.e., initial access broker, nation state actor, opportunistic actor, individual actor and/or multiple actors, related actors, related campaigns, related operations, cyber intrusion actor goals, targeted vulnerabilities, amongst other data.

At 204, the cyber intrusion attribution module 150 generates a plurality of Intrusion Comparison Data Sets (ICDS). The cyber intrusion attribution module 150 may generate an ICDS for each of a plurality of categories for both the incident data received from the Incident Tracking Platform and the actor intelligence data gathered from the Actor Intelligence Tracking Platform. The plurality of categories may include, but are not limited to including, Indicators of Compromise (IoCs) (e.g., Category 1 data), Tactics and Techniques (TTs) (e.g., Category 2 data), Extended IoC Characteristics (EI0CCs) (e.g., Category 3 data), and/or Miscellaneous Actor details (e.g., Category 4 data). As will be explained in more detail below, the ICDS for each of the plurality of categories may present the information for each of the plurality of categories in a structured way to facilitate comparison in subsequent steps.

In generating the ICDSs the incident and/or actor intelligence data may be processed by the cyber intrusion attribution module 150 utilizing one or more data normalization techniques. The cyber intrusion attribution module 150 may utilize at least the one or more data normalization techniques in the data processing phase such that the incident data and/or actor intelligence data may be normalized in a machine-readable format which may not include extraneous metadata. The machine-readable format may be one of a plurality of structured formats, such as, but not limited to, comma-separated values (CSV), extensible markup language (XML), Vocabulary for Event Recording and Incident Sharing (VERIS), Structured Threat Information Expression (STIX®) (STIX is a registered trademark of the U.S. Department of Homeland Security in the United States and/or other countries), a propriety structured data format, and/or other structured data formats. For example, if the data format being used is the JavaScript® Object Notation (JSON) (Javascript and all Javascript-based trademarks and logos are trademarks or registered trademarks of Oracle America, Inc. and/or its affiliates, in the United States and/or other countries) export of techniques from ATT&CK® Navigator (ATT&CK is a registered trademark of the MITRE Corporation in the United States and/or other countries), the subsequent data preparation would involve removing all data except for the JSON pertaining to the techniques present in that incident and/or cyber intrusion campaign and sorting the remaining data on the techniqueID.

The cyber intrusion attribution module 150 may utilize the EIoCCs (e.g., Category 3 data) collected though the Incident Tracking Platform and/or the Actor Intelligence Tracking Platform, to enrich the processed incident and/or actor intelligence data for IOCs (e.g., Category 1 data) in the structured format. The metadata enriched processed incident and/or actor intelligence data in machine-readable format may be utilized in generating the plurality of Intrusion Comparison Data Set (ICDS) which may be utilized as input data by the cyber intrusion attribution module 150.

At 206, the cyber intrusion attribution module 150 aggregates the plurality of ICDSs. The cyber intrusion attribution module 150 may aggregate each of the ICDSs for the plurality of categories for the incident data and the actor intelligence data. The cyber intrusion attribution module 150 may create a comprehensive ICDS for the incident data and the actor intelligence data.

The cyber intrusion attribution module 150 may generate a fuzzy hash for each ICDS and the comprehensive ICDS for both the incident data and the actor intelligence data. For example, the cyber intrusion attribution module 150 may generate 5 fuzzy hashes for the incident data and 5 fuzzy hashes for the actor intelligence data. The 5 fuzzy hashes may correspond to the comprehensive ICDS, Category 1 data ICDS, Category 2 data ICDS, Category 3 data ICDS, and Category 4 data ICDS for both the incident data and the actor intelligence data. As will be explained in more detail below with respect to step 208, the fuzzy hashes may be utilized by the cyber intrusion attribution module 150 in matching the incident ICDS against the actor intelligence ICDS. For example, one user may be primarily interested in the similarity ratings between the comprehensive ICDS of the actor intelligence data and the comprehensive ICDS for the incident data. While analysts that wish to analyze more granular information may find the comparison of fuzzy hashes between individual categories to be more informative. For example, an analyst may find it beneficial to understand an incident is very similar to a cyber intrusion actor in Category 2 data but extremely dissimilar from the same cyber intrusion actor in Category 1 data, which may indicate a cyber intrusion actor using their typical tactics and techniques (e.g., methodology) but with a brand new and/or completely customized indicators of compromise. In this example, these granular discoveries could indicate that the cyber intrusion actor may be specifically targeting the user and/or organization by customizing their intrusion as to not reuse known indicators of compromise.

At 208, the cyber intrusion attribution module 150 identifies potential actor attribution. The cyber intrusion attribution module 150 may identify the potential actor attribution by sharing the fuzzy hashes for individual category (e.g., Category 1, Category 2. Category 3, and Category 4) ICDSs and the comprehensive ICDS of the actor intelligence data to the Incident Tracking Platform.

The cyber intrusion attribution module 150 may apply one or more similarity algorithms (e.g., fuzzy hashing algorithms, fuzzy hash functions, rolling hash algorithms) in matching the actor intelligence ICDSs to the incident ICDSs using the fuzzy hashes. The cyber intrusion attribution module 150 may compare the fuzzy hashes for the incident ICDS with the corresponding actor intelligence ICDS.

The one or more similarity algorithms (e.g., fuzzy hashing algorithms, fuzzy hash functions, rolling hash algorithms) may be a type of compression functions for computing the similarity between individual digital files with cryptographic hashes that may not match. These similarity algorithms may typically be utilized in identifying malware that has been slightly modified to evade identification, here, the cyber intrusion attribution module 150 may apply that technique but to ICDSs. The one or more similarity algorithms (e.g., fuzzy hashing algorithms, fuzzy hash functions, rolling hash algorithms) which may be integrated into either the Incident Tracking Platform and/or the Actor Intelligence Tracking Platform may include, but are not limited to including, sdhash, mvhash, SSDeep, TSLH, Lempel-Ziv Jaccard distance, amongst other similarity algorithms. A high match rating between an incident and a cyber intrusion actor and/or cyber intrusion campaign as calculated using the one or more similarity algorithms and corresponding fuzzy hashes may indicate that the current incident has a high similarity to known characteristics of a cyber intrusion actor and/or cyber intrusion campaign.

The cyber intrusion attribution module 150 may identify potential actor attribution based on matches identified by the similarity algorithm above a predefined threshold. The predefined threshold may be set by a user to notify of a similarity between an incident and other similar cyber intrusions. The user and/or organization may set different predefined thresholds for each of the categories of data and/or for the comprehensive ICDS comparison. For example, an organization may wish to know of incidents having a significant similarity to cyber intrusion actors (e.g., above a predefined threshold of 50%). The organization may later decide that the organization is receiving too many potential cyber intrusion actors and may increase the predefined threshold to an 80% similarity.

The cyber intrusion attribution module 150 may highlight the matches above the predefined threshold and transmit as an output indicating a potential actor attribution. The cyber intrusion attribution module 150 may also transmit additional details as output including, but not limited to including, recommendations on websites to monitor for news about the potential cyber intrusion actors, suggestions on investigative threads for a forensic analysis to focus if an analysis remains ongoing, and/or recommendations on corrective actions to implement.

In an embodiment, the cyber intrusion attribution module 150 may also share the fuzzy hashes for individual category (e.g., Category 1, Category 2, Category 3, and Category 4) ICDSs and the comprehensive ICDS of the incident data to the Actor Intelligence Tracking Platform for similarity matching unless the incident response team classifies the incident with a restriction that may prevent sharing.

FIG. 3 provides a block diagram illustrating the flow of incident data and actor intelligence data tracking according to at least one embodiment. As shown by incident data recording 302 and gather actor intelligence data 304, the incident data recording 302 resulting from the incident and/or intrusion of the Incident Tracking Platform is occurring in a parallel cycle with the gathering of actor intelligence data 304 through the Actor Intelligence Tracking Platform. As described in detail above with respect to step 202, the two independent cycles may be performed in parallel to one another, the incident tracking may be completed in the Incident Tracking Platform and the actor intelligence data and/or tracking may be completed in the Actor Intelligence Tracking Platform.

Incident Data Processing 306 and Actor Intelligence Data Processing 308 are described in detail above with respect to 204. The incident and/or actor intelligence data may be processed utilizing one or more data normalizing techniques such that the plurality of categories, which may include, but are not limited to including Indicators of Compromise (IoCs) (e.g., Category 1 data), Tactics and Techniques (TTs) (e.g., Category 2 data), Extended IoC Characteristics (EI0CCs) (e.g., Category 3 data), and/or Miscellaneous Actor details (e.g., Category 4 data), may be normalized in a machine-readable format for both the incident data and actor intelligence data. The Incident Data Augmentation 310 and the Actor Intelligence Data Augmentation 312 are also described in detail at step 204 but refers to the enriching process of the normalized incident data and the normalized actor intelligence data using the EIoCCs (e.g., Category 3 data) collected through the Incident Tracking Platform and/or the Actor Intelligence Tracking Platform.

The Incident Intrusion Comparison Data Sets (ICDS) for each category 314 and the Actor Intelligence ICDSs for each category 316 are generated using the processing techniques and enriching techniques described above. The ICDSs for each category are then aggregated for the Incident ICDSs and the Actor Intelligence ICDSs. Generate Fuzzy Hashes 318 and 320, described in detail at step 206, the fuzzy hashes are generated for each categorical Incident ICDS, each categorical Actor Intelligence ICDS, the aggregated Incident ICDS, and the aggregated Actor Intelligence ICDS. The arrow from Generate Fuzzy Hashes 318 to Gather Actor Intelligence Data 304 may illustrate that while the two independent cycles may be performed in parallel, the incident data tracking may be utilized to inform the actor intelligence data tracking as described in more detail above with respect step 202.

Receive Actor Fuzzy Hashes 322 is described in detail at step 208 above and refers to the application of one or more similarity algorithms in matching the actor intelligence ICDS fuzzy hashes to the incident ICDS fuzzy hashes. The similarity algorithm may match Incident and Actor Intelligence Hashes 322 above a predefined threshold. Accordingly, those matches above the predefined threshold are highlighted 326 and utilized in identifying potential actor attribution.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for cyber intrusion attribution, the method comprising:
initiating incident data tracking and actor intelligence data tracking in response to an intrusion;
generating an intrusion comparison data set for each of a plurality of categories for both the incident data and the actor intelligence data;
comparing each intrusion comparison data set for the incident data with a corresponding intrusion comparison data set for the actor intelligence data; and
identifying a potential actor attribution based on comparing each of the intrusion comparison data sets for the incident data with the corresponding intrusion comparison data set for the actor intelligence data.

2. The method of claim 1, wherein initiating incident data tracking and actor intelligence data tracking further comprises:
processing the incident data and the actor intelligence data; and
augmenting the incident data and the actor intelligence data with extended indicators of compromise.

3. The method of claim 2, wherein processing the incident data and the actor intelligence data comprises normalizing the incident data and the actor intelligence data using one or more normalization techniques.

4. The method of claim 1, wherein comparing each intrusion comparison data set further comprises:
generating a fuzzy hash for each of the intrusion comparison data sets; and
applying one or more similarity algorithms in matching the corresponding intrusion comparison data set based on the fuzzy hashes.

5. The method of claim 1, wherein the incident data tracking is initiated in an Incident Tracking Platform and the actor intelligence data tracking is initiated in an Actor Intelligence Tracking Platform.

6. The method of claim 1, wherein the incident data tracking and the actor intelligence data tracking is conducted in two independent cycles being performed in parallel to one another.

7. The method of claim 1, further comprising:
creating an incident aggregate category intrusion comparison data set across the plurality of categories; and
creating an actor intelligence aggregate category intrusion comparison data set across the plurality of categories.

8. A computer system for cyber intrusion attribution, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
initiating incident data tracking and actor intelligence data tracking in response to an intrusion;
generating an intrusion comparison data set for each of a plurality of categories for both the incident data and the actor intelligence data;
comparing each intrusion comparison data set for the incident data with a corresponding intrusion comparison data set for the actor intelligence data; and
identifying a potential actor attribution based on comparing each of the intrusion comparison data sets for the incident data with the corresponding intrusion comparison data set for the actor intelligence data.

9. The computer system of claim 8, wherein initiating incident data tracking and actor intelligence data tracking further comprises:
program instructions, stored on at least one of the one or more computer-readable storage media for execution by at least one of the one or more processors via at least one of the one or more memories, to process the incident data and the actor intelligence data; and
program instructions, stored on at least one of the one or more computer-readable storage media for execution by at least one of the one or more processors via at least one of the one or more memories, to augment the incident data and the actor intelligence data with extended indicators of compromise.

10. The computer system of claim 9, wherein processing the incident data and the actor intelligence data comprises normalizing the incident data and the actor intelligence data using one or more normalization techniques.

11. The computer system of claim 8, wherein comparing each intrusion comparison data set further comprises:
program instructions, stored on at least one of the one or more computer-readable storage media for execution by at least one of the one or more processors via at least one of the one or more memories, to generate a fuzzy hash for each of the intrusion comparison data sets; and
program instructions, stored on at least one of the one or more computer-readable storage media for execution by at least one of the one or more processors via at least one of the one or more memories, to apply one or more similarity algorithms in matching the corresponding intrusion comparison data set based on the fuzzy hashes.

12. The computer system of claim 8, wherein the incident data tracking is initiated in an Incident Tracking Platform and the actor intelligence data tracking is initiated in an Actor Intelligence Tracking Platform.

13. The computer system of claim 8, wherein the incident data tracking and the actor intelligence data tracking is conducted in two independent cycles being performed in parallel to one another.

14. The computer system of claim 8, further comprising:
program instructions, stored on at least one of the one or more computer-readable storage media for execution by at least one of the one or more processors via at least one of the one or more memories, to create an incident aggregate category intrusion comparison data set across the plurality of categories; and
program instructions, stored on at least one of the one or more computer-readable storage media for execution by at least one of the one or more processors via at least one of the one or more memories, to create an actor intelligence aggregate category intrusion comparison data set across the plurality of categories.

15. A computer program product for cyber intrusion attribution, comprising:
one or more computer readable storage media, and program instructions collectively stored on the one or more computer readable storage media, the program instructions comprising:
initiating incident data tracking and actor intelligence data tracking in response to an intrusion;
generating an intrusion comparison data set for each of a plurality of categories for both the incident data and the actor intelligence data;
comparing each intrusion comparison data set for the incident data with a corresponding intrusion comparison data set for the actor intelligence data; and
identifying a potential actor attribution based on comparing each of the intrusion comparison data sets for the incident data with the corresponding intrusion comparison data set for the actor intelligence data.

16. The computer program product of claim 15, wherein initiating incident data tracking and actor intelligence data tracking further comprises:
program instructions, stored on at least one of the one or more computer-readable storage media, to process the incident data and the actor intelligence data; and
program instructions, stored on at least one of the one or more computer-readable storage media, to augment the incident data and the actor intelligence data with extended indicators of compromise.

17. The computer program product of claim 16, wherein processing the incident data and the actor intelligence data comprises normalizing the incident data and the actor intelligence data using one or more normalization techniques.

18. The computer program product of claim 15, wherein comparing each intrusion comparison data set further comprises:
program instructions, stored on at least one of the one or more computer-readable storage media, to generate a fuzzy hash for each of the intrusion comparison data sets; and
program instructions, stored on at least one of the one or more computer-readable storage media, to apply one or more similarity algorithms in matching the corresponding intrusion comparison data set based on the fuzzy hashes.

19. The computer program product of claim 15, wherein the incident data tracking is initiated in an Incident Tracking Platform and the actor intelligence data tracking is initiated in an Actor Intelligence Tracking Platform.

20. The computer program product of claim 15, wherein the incident data tracking and the actor intelligence data tracking is conducted in two independent cycles being performed in parallel to one another.
